(19) United States
(12) Patent Application Publication
(10) Pub. No.: US 2025/0368893 A1
(43) Pub. Date: Dec. 4, 2025

(54) SELECTIVE SILICON NITRIDE ETCHING COMPOSITIONS AND RELATED SYSTEMS AND RELATED METHODS

(71) Applicant: ENTEGRIS, INC., Billerica, MA (US)

(72) Inventors: JuHee Yeo, Suwon (KR); Yeonhui Kang, Seoul (KR); SeongJin Hong, Cheongju-si (KR); YoungHun Park, Seoul (KR); Jinwook Jeong, Suwon-si (KR); WonLae Kim, Gunpo-si (KR)

(21) Appl. No.: 19/222,568

(22) Filed: May 29, 2025

Related U.S. Application Data
(60) Provisional application No. 63/654,337, filed on May 31, 2024.

(51) Int. Cl. C09K 13/06

(52) U.S. Cl. CPC C09K 13/06

(57) ABSTRACT

Selective nitride etchant compositions for reducing form and related methods are provided herein. The composition comprises a phosphoric acid; a water; and an alkyl silane compound. A substrate comprises a silicon nitride portion of the substrate and a silicon portion of the substrate. At least 25% of the silicon nitride portion is removed after contacting a surface of the substrate with the composition.

### CROSS-REFERENCE TO RELATED APPLICATIONS

This application claims the benefit under 35 USC 119 of U.S. Provisional Patent Application No. 63/654,337, filed May 31, 2024, the disclosure of which is hereby incorporated herein by reference in its entirety.

### FIELD

The present disclosure relates to selective silicon nitride etching compositions, and related systems and related methods.

### BACKGROUND

Manufacture of microelectronic devices involves material removal via etching. The removal of these materials via etching can also result in the undesirable removal of other materials.

### SUMMARY

Some embodiments relate to a composition. In some embodiments, the composition comprises a phosphoric acid, a water, and an alkyl silane compound. In some embodiments, the alkyl silane compound comprises a compound of the formula:

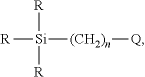

where:
R is independently a hydrogen, a halide, a hydroxide, an alkyl, or an alkoxide;
Q is a cyanide, a carboxylate, an amide, or a quaternary ammonium; and
n is at least 1.

Some embodiments relate to a method. In some embodiments, the method comprises obtaining a structure comprising a silicon nitride and a silicon oxide. In some embodiments, the method comprises contacting the structure with a composition to remove at least a portion of the silicon nitride. In some embodiments, the composition comprises a phosphoric acid, a water, and an alkyl silane compound. In some embodiments, the alkyl silane compound comprises a compound of the formula:

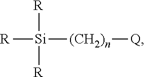

where:
R is independently a hydrogen, a halide, a hydroxide, an alkyl, or an alkoxide;
Q is a cyanide, a carboxylate, an amide, or a quaternary ammonium; and
n is at least 1.

Some embodiments relate to a substrate. In some embodiments, the substrate comprises a silicon nitride portion of the substrate. In some embodiments, the substrate comprises a silicon oxide portion of the substrate. In some embodiments, at least 25% of the silicon nitride portion is removed after contacting a surface of the substrate with the composition. In some embodiments, the composition comprises a phosphoric acid, a water, and an alkyl silane compound. In some embodiments, the alkyl silane compound comprises a compound of the formula:

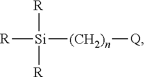

where:
R is independently a hydrogen, a halide, a hydroxide, an alkyl, or an alkoxide;
Q is a cyanide, a carboxylate, an amide, or a quaternary ammonium; and
n is at least 1.

### DRAWINGS

FIG. 1 is a flowchart of a method 100 for reduced foaming for selective nitride etch at elevated temperatures, according to some embodiments.

### DETAILED DESCRIPTION

As used herein, the term “contacting” refers to bringing two or more components into immediate or close proximity, or into direct contact.

As used herein, the term “alkyl” refers to a hydrocarbyl having from 1 to 30 carbon atoms. The alkyl may be attached via a single bond. An alkyl having n carbon atoms may be designated as a “Cₙ alkyl.” For example, a “C₃ alkyl” may include n-propyl and isopropyl. An alkyl having a range of carbon atoms, such as 1 to 30 carbon atoms, may be designated as a C₁-C₃₀ alkyl. In some embodiments, the alkyl is linear. In some embodiments, the alkyl is branched. In some embodiments, the alkyl is substituted. In some embodiments, the alkyl is unsubstituted. In some embodiments, the alkyl comprises or is selected from the group consisting of at least one of a C₁-C₃₀ alkyl, C₁-C₂₉ alkyl, C₁-C₂₈ alkyl, C₁-C₂₇ alkyl, C₁-C₂₇ alkyl, C₁-C₂₆ alkyl, C₁-C₂₅ alkyl, C₁-C₂₄ alkyl, C₁-C₂₃ alkyl, C₁-C₂₂ alkyl, C₁-C₂₁ alkyl, C₁-C₂₀ alkyl, C₁-C₁₉ alkyl, C₁-C₁₈ alkyl, C₁-C₁₇ alkyl, C₁-C₁₆ alkyl, C₁-C₁₅ alkyl, C₁-C₁₄ alkyl, C₁-C₁₃ alkyl, C₁-C₁₂ alkyl, C₁-C₁₁ alkyl, C₁-C₁₀ alkyl, a C₁-C₉ alkyl, a C₁-C₈ alkyl, a C₁-C₇ alkyl, a C₁-C₆ alkyl, a C₁-C₅ alkyl, a C₁-C₄ alkyl, a C₁-C₃ alkyl, a C₁-C₂ alkyl, a C₂-C₃₀ alkyl, a C₃-C₃₀ alkyl, a C₄-C₃₀ alkyl, a C₅-C₃₀ alkyl, a C₆-C₃₀ alkyl, a C₇-C₃₀ alkyl, a C₈-C₃₀ alkyl, a C₉-C₃₀ alkyl, a C₁₀-C₃₀ alkyl, a C₁₁-C₃₀ alkyl, a C₁₂-C₃₀ alkyl, a C₁₃-C₃₀ alkyl, a C₁₄-C₃₀ alkyl, a C₁₅-C₃₀ alkyl, a C₁₆-C₃₀ alkyl, a C₁₇-C₃₀ alkyl, a C₁₈-C₃₀ alkyl, a C₁₉-C₃₀ alkyl, a C₂₀-C₃₀ alkyl, a C₂₁-C₃₀ alkyl, a C₂₂-C₃₀ alkyl, a C₂₃-C₃₀ alkyl, a C₂₄-C₃₀ alkyl, a C₂₅-C₃₀ alkyl, a C₂₆-C₃₀ alkyl, a C₂₇-C₃₀ alkyl, a C₂₈-C₃₀ alkyl, a C₂₉-C₃₀ alkyl, a C₂-C₁₀ alkyl, a C₃-C₁₀ alkyl, a C₄-C₁₀ alkyl, a C₅-C₁₀ alkyl, a C₆-C₁₀ alkyl, a C₇-C₁₀ alkyl, a C₈-C₁₀ alkyl, a C₂-C₉ alkyl, a C₂-C₈ alkyl, a C₂-C₇ alkyl, a C₂-C₆ alkyl, a C₂-C₅ alkyl, a C₃-C₅ alkyl, or any combination thereof. In some embodiments, the alkyl comprises or is selected from the group consisting of at least one of methyl, ethyl, n-propyl, 1-methylethyl (iso-propyl), n-butyl, iso-butyl, sec-butyl, n-pentyl, 1,1-dimethylethyl (t-butyl), n-pentyl, iso-pentyl, n-hexyl, isohexyl, 3-methylhexyl, 2-methylhexyl, heptyl, octyl, nonyl, decyl, dodecyl, octadecyl, or any combination thereof. In some embodiments, the term “alkyl” refers generally to alkyls, alkenyls, alkynyls, and/or cycloalkyls.

As used herein, the term “cycloalkyl” refers to a non-aromatic carbocyclic ring having from 3 to 8 carbon atoms in the ring. The term includes a monocyclic non-aromatic carbocyclic ring and a polycyclic non-aromatic carbocyclic ring. The term “monocyclic,” when used as a modifier, refers to a cycloalkyl having a single cyclic ring structure. The term “polycyclic,” when used as a modifier, refers to a cycloalkyl having more than one cyclic ring structure, which may be fused, bridged, spiro, or otherwise bonded ring structures. For example, two or more cycloalkyls may be fused, bridged, or fused and bridged to obtain the polycyclic non-aromatic carbocyclic ring. In some embodiments, the cycloalkyl may comprise, consist of, or consist essentially of, or may be selected from the group consisting of, at least one of cyclopropyl, cyclobutyl, cyclopentyl, cyclohexyl, cycloheptyl, cyclooctyl, or any combination thereof.

As used herein, the term “aryl” refers to a monocyclic or polycyclic aromatic hydrocarbon. The number of carbon atoms of the aryl may be in a range of 5 carbon atoms to 100 carbon atoms. In some embodiments, the aryl has 5 to 20 carbon atoms. For example, in some embodiments, the aryl has 6 to 8 carbon atoms, 6 to 10 carbon atoms, 6 to 12 carbon atoms, 6 to 15 carbon atoms, or 6 to 20 carbon atoms. The term “monocyclic,” when used as a modifier, refers to an aryl having a single aromatic ring structure. The term “polycyclic,” when used as a modifier, refers to an aryl having more than one aromatic ring structure, which may be fused, bridged, spiro, or otherwise bonded ring structures. In some embodiments, the aryl is —C₆H₅.

Non-limiting examples of aryls include, without limitation, at least one of benzene, toluene, xylene (e.g., o-xylene, m-xylene, p-xylene), t-butyltoluene (e.g., o-t-butyltoluene, m-t-butyltoluene, p-t-butyltoluene), ethylmethylbenzene (e.g., 1-ethyl-4-methylbenzene, 1-ethyl-3-methylbenzene), 1-isopropyl-4-methylbenzene, 1-t-butyl-4-methylbenzene, mesitylene, pseudocumene, durene, methylbenzene, dimethylbenzene, trimethylbenzene, ethylbenzene, diethylbenzene (e.g., 1,4-diethylbenzene), triethylbenzene, propylbenzene, butylbenzene, iso-butylbenzene, sec-butylbenzene, t-butylbenzene, hexylbenzene, styrene, naphthalene, anthracene, phenanthrene, biphenyl, terphenyl, methylnaphthalene, biphenylene, dimethylnaphthalene, methylanthracene, 4,4′-dimethylbiphenyl, bibenzyl, diphenylmethane, any isomer thereof, or any combination thereof, and the like.

As used herein, the term “alkoxyalkyl” refers to an alkyl as defined herein, wherein at least one of the hydrogen atoms of the alkyl is replaced with an alkoxy as defined herein. In some embodiments, the term “alkoxyalkyl” refers to a functional group of formula -(alkyl)OR^{a}, wherein the alkyl is defined above and wherein the R^{a} is defined above. In some embodiments, the alkoxyalkyl is a functional group of formula —(CH₂)ₙOR^{a}, where n is 1 to 10 and R^{a} is defined above. In some embodiments, the alkoxyalkyl is a functional group of the formula —CH₂CH₂OCH₃.

As used herein, the term “aralkyl” refers to an alkyl as defined herein, wherein at least one of the hydrogen atoms of the alkyl is replaced with an aryl as defined herein. In some embodiments, the term “aralkyl” refers to a functional group of formula -(alkyl)(aryl), wherein the alkyl is defined herein and the aryl is defined herein. In some embodiments, the aralkyl is —CH₂(C₆H₅).

As used herein, the term “halide” refers to a —Cl, —Br, —I, or —F.

As used herein, “remove at least a portion of the silicon nitride” corresponds to the removal of at least a portion of the exposed silicon nitride layer. For example, the removal of silicon nitride material includes the anisotropic removal of a silicon nitride layer that covers/protects the gate electrodes to form a Si₃N₄ sidewall. It is also contemplated herein that the compositions of the present invention may be used more generally to substantially remove silicon nitride material relative to poly-silicon and/or silicon oxide layers. In those circumstances, “substantial removal” is defined in one embodiment as at least 90%, in another embodiment at least 95%, and in yet another embodiment at least 99% of the silicon nitride material is removed using the compositions of the invention.

Some embodiments relate to selective nitride etchant compositions and related methods. The selective nitride etchant compositions are useful in microelectronic applications, including, for example and without limitation, semiconductor applications. The compositions disclosed herein may be employed as a selective nitride etchant. For example, in some embodiments, the compositions disclosed herein are useful for selectively removing silicon nitride, while also suppressing regrowth of the silicon oxide layer and reducing foaming (e.g., at elevated temperatures). In some embodiments, the composition comprises an inhibitor. In some embodiments, the inhibitor comprises an alkyl silane compound. In some embodiments, the inhibitor results in at least one of less foaming at elevated temperatures, high selectivity for silicon nitride over silicon oxide, enhanced silicon loading margin, increased silicon loading window, or any combination thereof.

In some embodiments, the composition comprises a phosphoric acid (H₃PO₄). The phosphoric acid may selectively remove silicon nitride. In some embodiments, the composition comprises 75% to 90% by weight of the phosphoric acid based on a total weight of the composition or any range or subrange between 75% to 90%. In some embodiments, the composition comprises 75% to 89%, 75% to 88%, 75% to 87%, 75% to 86%, 75% to 85%, 75% to 84%, 75% to 83%, 75% to 82%, 75% to 81%, 75% to 80%, 75% to 79%, 75% to 78%, 75% to 77%, 75% to 76%, 76% to 90%, 77% to 90%, 78% to 90%, 79% to 90%, 80% to 90%, 81% to 90%, 82% to 90%, 83% to 90%, 84% to 90%, 85% to 90%, 86% to 90%, 87% to 90%, 88% to 90%, or 89% to 90% by weight of the phosphoric acid based on the total weight of the composition.

In some embodiments, the composition comprises a water. The water may catalyze the surface reaction. The water may readily dissociate and provide a more reactive species responsible for higher silicon nitride etch rates at elevated temperatures.

In some embodiments, the composition comprises an alkyl silane compound. In some embodiments, the alkyl silane compound may be an inhibitor. The inhibitor may increase the selective etching of silicon nitride when the inhibitor is added to the phosphoric acid. In some embodiments, the composition may have a higher selectivity for etching silicon nitride than conventional silicon nitride etchants. The alkyl silane compound may reduce foam generated during the etching process. In some embodiments, at high temperatures, the alkyl silane compound may not result in foaming.

In some embodiments, the alkyl silane compound comprises a compound of the formula:

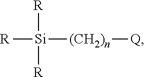

where:
R is independently a hydrogen, a halide, a hydroxide, an alkyl, or an alkoxide.
Q is a cyanide, a carboxylate, an amide, or a quaternary ammonium; and
n is at least 1.

In some embodiments, the composition may not produce foam at elevated temperatures.

In some embodiments, R may be a hydroxide.

In some embodiments, R may be an alkoxide.

In some embodiments, Q may be a cyanide and the cyanide comprises:

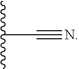 [SMILES: *C#N]

In some embodiments, Q may be an amide and the amide comprises:

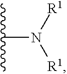

where:
R¹ is independently an alkyl, an aryl, an isoprene, a silane, or a hydrogen.

In some embodiments, the silane comprises butyltrimethoxysilane.

In some embodiments, Q may be a carboxylate and the carboxylate comprise:

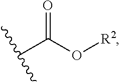

where:
R² is a hydrogen or an alkyl.

In some embodiments, Q may be a quaternary ammonium and the quaternary ammonium comprises:

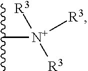

where:
R³ is independently an alkyl, an aryl, an acid, a silane, a hydrogen, or any combination thereof.

For example, in some embodiments, the acid comprises at least one of an alkanesulfonic acid, a 1-butanesulfonic acid, or any combination thereof. In some embodiments, the silane comprises a butyltrimethoxysilane.

In some embodiments, the alkyl silane compound comprises a compound of the formula:

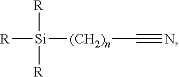

where:
R is independently a hydrogen, a halide, a hydroxide, an alkyl, or an alkoxide; and
n is at least 1.

In some embodiments, the alkyl silane compound comprises a compound of the formula:

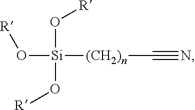

where:
R′ is independently a hydrogen or an alkyl; and
n is at least 1.

In some embodiments, the alkyl silane compound comprises a compound of the formula:

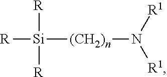

where:
R is independently a hydrogen, a halide, a hydroxide, an alkyl, or an alkoxide;
R¹ is independently a hydrogen, an alkyl, a cycloalkyl, an aryl, an alkaryl, an aralkyl, or an alkoxyalkyl; and
n is at least 1.

In some embodiments, the alkyl silane compound comprises a compound of the formula:

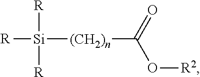

where:
R is independently a hydrogen, a halide, a hydroxide, an alkyl, or an alkoxide;
R² is a hydrogen or an alkyl; and
n is at least 1.

In some embodiments, the alkyl silane compound comprises a compound of the formula:

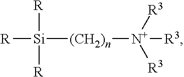

where:
R is independently a hydrogen, a halide, a hydroxide, an alkyl, or an alkoxide; and
R³ is independently a hydrogen, an isoprene, or an alkyl.

The composition may comprise 0.1% to 10% by weight of the alkyl silane compound based on the total weight of the composition, or any range or subrange between 0.1% and 10%. In some embodiments, the composition comprises 0.1% to 9.5%, 0.1% to 9%, 0.1% to 8.5%, 0.1% to 8%, 0.1% to 7.5%, 0.1% to 7%, 0.1% to 6.5%, 0.1% to 6%, 0.1% to 5.5%, 0.1% to 5%, 0.1% to 4.5%, 0.1% to 4%, 0.1% to 3.5%, 0.1% to 3%, 0.1% to 2.5%, 0.1% to 2%, 0.1% to 1.5%, 0.1% to 1%, 0.1% to 0.9%, 0.1% to 0.8%, 0.1% to 0.7%, 0.1% to 0.6%, 0.1% to 0.5%, 0.1% to 0.4%, 0.1% to 0.3%, or 0.1% to 0.2% by weight of the alkyl silane compound based on the total weight of the composition. In some embodiments, the composition comprises 0.2% to 10%, 0.3% to 10%, 0.3% to 10%, 0.4% to 10%, 0.5% to 10%, 0.6% to 10%, 0.7% to 10%, 0.8% to 10%, 0.9% to 10%, 1% to 10%, 1.5% to 10%, 2% to 10%, 2.5% to 10%, 3% to 10%, 3.5% to 10%, 4% to 10%, 4.5% to 10%, 5% to 10%, 5.5% to 10%, 6% to 10%, 6.5% to 10%, 7% to 10%, 7.5% to 10%, 8% to 10%, 8.5% to 10%, 9% to 10%, or 9.5% to 10% by weight of the alkyl silane compound based on the total weight of the composition.

The composition may reduce foam generated during silicon nitride etchant. In some embodiments, the composition may reduce foam generated during silicon nitride etchant at elevated temperatures, such as, for example and without limitation, 30 Celsius (° C.) to 200° C., or any range or subrange between 30° C. and 200° C. In some embodiments, the elevated temperature is a temperature in a range of 30° C. to 190° C., 30° C. to 180° C., 30° C. to 170° C., 30° C. to 160° C., 30° C. to 150° C., 30° C. to 140° C., 30° C. to 130° C., 30° C. to 120° C., 30° C. to 110° C., 30° C. to 100° C., 30° C. to 90° C., 30° C. to 80° C., 30° C. to 70° C., 30° C. to 60° C., 30° C. to 50° C., or 30° C. to 40° C. In some embodiments, the elevated temperature is a temperature in a range of 40° C. to 200° C., 50° C. to 200° C., 60° C. to 200° C., 70° C. to 200° C., 80° C. to 200° C., 90° C. to 200° C., 100° C. to 200° C., 110° C. to 200° C., 120° C. to 200° C., 130° C. to 200° C., 140° C. to 200° C., 150° C. to 200° C., 160° C. to 200° C., 170° C. to 200° C., 180° C. to 200° C., or 190° C. to 200° C.

In some embodiments, the composition may produce no foam during silicon nitride etchant at elevated temperatures. In some embodiments, the composition produces no foam at temperatures ranging from 30 Celsius (° C.) to 200° C., or any range or subrange between 30° C. and 200° C. For example, in some embodiments, the composition produces no foam at temperatures ranging from 40° C. to 190° C., 50° C. to 180° C., 60° C. to 170° C., 70° C. to 160° C., 80° C. to 150° C., 90° C. to 140° C., 100° C. to 130° C., or 110° C. to 120° C. In some embodiments, the composition produces no foam at temperatures ranging from 30° C. to 190° C., 30° C. to 180° C., 30° C. to 170° C., 30° C. to 160° C., 30° C. to 150° C., 30° C. to 140° C., 30° C. to 130° C., 30° C. to 120° C., 30° C. to 110° C., 30° C. to 100° C., 30° C. to 90° C., 30° C. to 80° C., 30° C. to 70° C., 30° C. to 60° C., 30° C. to 50° C., or 30° C. to 40° C. In some embodiments, the composition produces no foam at temperatures ranging from 40° C. to 200° C., 50° C. to 200° C., 60° C. to 200° C., 70° C. to 200° C., 80° C. to 200° C., 90° C. to 200° C., 100° C. to 200° C., 110° C. to 200° C., 120° C. to 200° C., 130° C. to 200° C., 140° C. to 200° C., 150° C. to 200° C., 160° C. to 200° C., 170° C. to 200° C., 180° C. to 200° C., or 190° C. to 200° C.

In some embodiments, the composition may have a silicon loading margin ranging from 0 parts per million (ppm) to 1000 ppm, or any range or subrange between 0 ppm and 1000 ppm. For example, in some embodiments, the silicon loading margin ranges from 50 ppm to 950 ppm, 100 ppm to 900 ppm, 150 ppm to 850 ppm, 200 ppm to 800 ppm, 250 ppm to 750 ppm, 300 ppm to 700 ppm, 350 ppm to 650 ppm, 400 ppm to 600 ppm, or 450 ppm to 550 ppm. In some embodiments, the silicon loading margin ranges from 0 ppm to 900 ppm, 0 ppm to 800 ppm, 0 ppm to 700 ppm, 0 ppm to 600 ppm, 0 ppm to 500 ppm, 0 ppm to 400 ppm, 0 ppm to 300 ppm, 0 ppm to 200 ppm, or 0 ppm to 100 ppm. In some embodiments, the silicon loading margin ranges from 100 ppm to 1000 ppm, 200 ppm to 1000 ppm, 300 ppm to 1000 ppm, 400 ppm to 1000 ppm, 500 ppm to 1000 ppm, 600 ppm to 1000 ppm, 700 ppm to 1000 ppm, 800 ppm to 1000 ppm, or 900 ppm to 1000 ppm.

In some embodiments, the composition may exhibit a SiNₓ etch rate ranging from 30 angstrom per minute (Å/min) to 120 Å/min, or any range or subrange between 30 Å/min and 120 Å/min. For example, in some embodiments, the composition may have a SiNₓ etch rate ranging from 40 Å/min to 110 Å/min, 50 Å/min to 100 Å/min, 60 Å/min to 90 Å/min, or 70 Å/min to 80 Å/min. In some embodiments, the composition may have a SiNₓ etch rate ranging from 30 Å/min to 110 Å/min, 30 Å/min and 100 Å/min, 30 Å/min and 90 Å/min, 30 Å/min and 80 Å/min, 30 Å/min to 70 Å/min, 30 Å/min and 60 Å/min, 30 Å/min and 50 Å/min, or 30 Å/min and 40 Å/min. In some embodiments, the composition may have a SiN_{X} etch rate ranging from 40 Å/min to 120 Å/min, 50 Å/min to 120 Å/min, 60 Å/min to 120 Å/min, 70 Å/min to 120 Å/min, 80 Å/min to 120 Å/min, 90 Å/min to 120 Å/min, 100 Å/min to 120 Å/min, or 110 Å/min to 120 Å/min.

In some embodiments, the composition may exhibit a SiOₓ etch rate ranging from 0.01 Å/min to 3 Å/min, or any range or subrange between 0.01 Å/min to 3 Å/min. For example, in some embodiments, the composition may have a SiOₓ etch rate ranging from 0.10 Å/min to 2.5 Å/min, 0.50 Å/min to 2 Å/min, or 1 Å/min to 2 Å/min. In some embodiments, the composition may have a SiOₓ etch rate ranging from 0.10 Å/min to 2.5 Å/min, 0.50 Å/min to 2 Å/min, or 1 Å/min to 2 Å/min. In some embodiments, the composition may have a SiOₓ etch rate ranging from 0.01 Å/min to 2.5 Å/min, 0.01 Å/min to 2 Å/min, 0.01 Å/min to 2 Å/min, 0.01 Å/min to 1.5 Å/min, 0.01 Å/min to 1 Å/min, 0.01 Å/min to 0.5 Å/min, or 0.01 Å/min to 0.1 Å/min. In some embodiments, the composition may have a SiOₓ etch rate ranging from 0.10 Å/min to 3 Å/min, 0.50 Å/min to 3 Å/min, 1 Å/min to 3 Å/min, 1.50 Å/min to 3 Å/min, 2 Å/min to 3 Å/min, or 2.5 Å/min to 3 Å/min.

In some embodiments, the composition may result in a foam height at room temperature ranging from 0.1 millimeters (mm) to 60 mm, or any range or subrange between 0.1 mm and 60 mm. For example, in some embodiments, the composition may have a foam height at room temperature ranging from 0.5 mm to 50 mm, 1 mm to 45 mm, 5 mm to 40 mm, 10 mm to 35 mm, 15 mm to 30 mm, or 20 mm to 25 mm. In some embodiments, the composition may have a foam height at room temperature ranging from 0.5 mm to 50 mm, 1 mm to 50 mm, 5 mm to 50 mm, 10 mm to 50 mm, 15 mm to 50 mm, 20 mm to 50 mm, 25 mm to 50 mm, 30 mm to 50 mm, 35 mm to 50 mm, 40 mm to 50 mm, or 45 mm to 50 mm. In some embodiments, the composition may have a foam height at room temperature ranging from 0.1 mm to 45 mm, 0.1 mm to 40 mm, 0.1 mm to 35 mm, 0.1 mm to 30 mm, 0.1 mm to 25 mm, 0.1 mm to 20 mm, 0.1 mm to 15 mm, 0.1 mm to 10 mm, 0.1 mm to 5 mm, 0.1 mm to 1 mm, or 0.1 mm to 0.5 mm.

In some embodiments, the composition may result in a foam height at an elevated temperature ranging from 0.1 mm to 10 mm, or any range or subrange between 0.1 mm and 10 mm. For example, in some embodiments, the composition may have a foam height at room temperature ranging from 0.5 mm to 9 mm, 1 mm to 8 mm, 2 mm to 7 mm, 3 mm to 6 mm, or 4 mm to 5 mm. In some embodiments, the composition may have a foam height at room temperature ranging from 0.1 mm to 9 mm, 0.1 mm to 8 mm, 0.1 mm to 7 mm, 0.1 mm to 6 mm, 0.1 mm to 5 mm, 0.1 mm to 4 mm, 0.1 mm to 3 mm, 0.1 mm to 2 mm, 0.1 mm to 1 mm, or 0.1 mm to 0.5 mm. In some embodiments, the composition may have a foam height at room temperature ranging from 0.5 mm to 10 mm, 1 mm to 10 mm, 2 mm to 10 mm, 3 mm to 10 mm, 4 mm to 10 mm, 5 mm to 10 mm, 6 mm to 10 mm, 7 mm to 10 mm, 8 mm to 10 mm, or 9 mm to 10 mm.

In some embodiments, the composition may have a pH ranging from 0 to 9, or any range or subrange between 0 and 9. For example, in some embodiments, the composition may have a pH ranging from 1 to 8, 2 to 7, 3 to 6, or 4 to 5. In some embodiments, the composition may have a pH ranging from 0 to 8, 0 to 7, 0 to 6, 0 to 5, 0 to 4, 0 to 3, 0 to 2, or 0 to 1. In some embodiments, the composition may have a pH ranging from 1 to 9, 2 to 9, 3 to 9, 4 to 9, 5 to 9, 6 to 9, 7 to 9, or 8 to 9.

In some embodiments, the composition may have a pH ranging from 0 to 1, or any range or subrange between 0 and 1. For example, in some embodiments, the composition may have a pH ranging from 0.1 to 0.9, 0.2 to 0.8, 0.3 to 0.7, or 0.4 to 0.6. In some embodiments, the composition may have a pH ranging from 0 to 0.9, 0 to 0.8, 0 to 0.7, 0 to 0.6, 0 to 0.5, 0 to 0.4, 0 to 0.3, 0 to 0.2, or 0 to 0.1. In some embodiments, the composition may have a pH ranging from 0.1 to 1, 0.2 to 1, 0.3 to 1, 0.4 to 1, 0.5 to 1, 0.6 to 1, 0.7 to 1, 0.8 to 1, or 0.9 to 1.

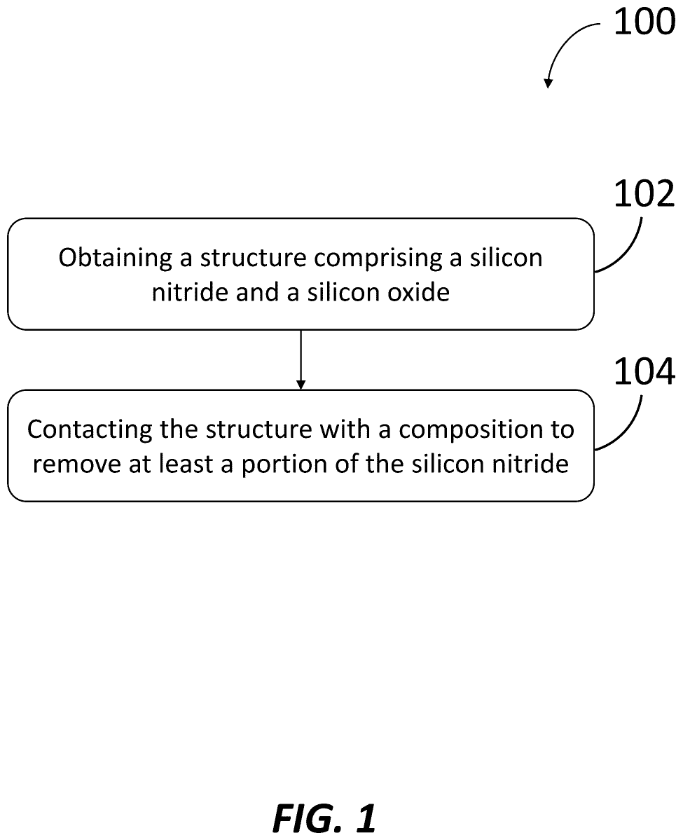

FIG. 1 is a flowchart of a method, according to some embodiments. In some embodiments, the method 100 may comprise one or more of the following steps: a step 102 of obtaining a structure comprising a silicon nitride and a silicon oxide; and a step 104 of contacting the structure with a composition to remove at least a portion of the silicon nitride.

At step 102, in some embodiments, the method 100 comprises obtaining a structure comprising a silicon nitride and a silicon oxide. In some embodiments, the structure may be a microelectronic device comprising a substrate.

At step 104, in some embodiment, the method 100 comprises contacting the structure with a composition to remove at least a portion of the silicon nitride. The silicon nitride may be selective relative to the silicon oxide.

As disclosed herein, the composition comprises a phosphoric acid, a water, and an alkyl silane compound.

In some embodiments, the alkyl silane compound comprises a compound of the formula:

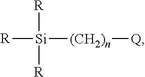

where:
R is independently a hydrogen, a halide, a hydroxide, an alkyl, or an alkoxide;
Q is a cyanide, a carboxylate, an amide, or a quaternary ammonium; and
n is at least 1.

In some embodiments, the alkyl silane compound comprises a compound of the formula:

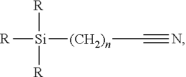

where:
R is independently a hydrogen, a halide, a hydroxide, an alkyl, or an alkoxide; and
n is at least 1.

In some embodiments, the alkyl silane compound comprises a compound of the formula:

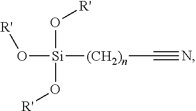

where:
R′ is independently a hydrogen or an alkyl; and
n is at least 1.

In some embodiments, the alkyl silane compound comprises a compound of the formula:

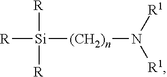

where:
R is independently a hydrogen, a halide, a hydroxide, an alkyl, an isoprene, or an alkoxide;
R¹ is independently a hydrogen, an alkyl, a cycloalkyl, an aryl, an alkaryl, an aralkyl, or an alkoxyalkyl; and
n is at least 1.

In some embodiments, the alkyl silane compound comprises a compound of the formula:

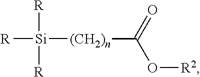

where:
R is independently a hydrogen, a halide, a hydroxide, an alkyl, or an alkoxide;
R² is a hydrogen or an alkyl; and
n is at least 1.

In some embodiments, the alkyl silane compound comprises a compound of the formula:

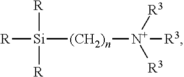

where:
R is independently a hydrogen, a halide, a hydroxide, an alkyl, or an alkoxide; and
R³ is a hydrogen, an isoprene, or an alkyl.

In some embodiments, the contacting comprises bringing a structure and a composition into immediate or close proximity. In some embodiments, the contacting comprises bringing a structure and a composition into direct physical contact. In some embodiments, the contacting comprises exposing the structure to the composition. In some embodiments, the contacting comprises introducing, supplying, pumping, injecting, flowing, or otherwise providing the composition to the structure. In some embodiments, the contacting comprises adding the composition to the structure. In some embodiments, the contacting comprises combining the structure and the composition. In some embodiments, the contacting comprises pouring the composition onto the structure. In some embodiments, the structure, and the composition are contacted sequentially, in any order. In some embodiments, the structure, and the composition are contacted substantially simultaneously or simultaneously.

In some embodiments, contacting the structure with a composition may occur for a time ranging from 1 minute to 200 minutes, or any range or subrange between 1 minutes and 200 minutes. For example, in some embodiments, contacting the structure with the composition my occur for a time ranging from 10 minutes to 190 minutes, 20 minutes to 180 minutes, 30 minutes to 170 minutes, 40 minutes to 160 minutes, 50 minutes to 150 minutes, 60 minutes to 140 minutes, 70 minutes to 130 minutes, 80 minutes to 120 minutes, or 90 minutes to 110 minutes. In some embodiments, contacting the structure with the composition my occur for a time ranging from 20 minutes to 200 minutes, 40 minutes to 200 minutes, 60 minutes to 200 minutes, 80 minutes to 200 minutes, 100 minutes to 200 minutes, 120 minutes to 200 minutes, 140 minutes to 200 minutes, 160 minutes to 200 minutes, or 180 minutes to 200 minutes. In some embodiments, contacting the structure with the composition my occur for a time ranging from 1 minute to 180 minutes, 1 minute to 160 minutes, 1 minute to 140 minutes, 1 minute to 120 minutes, 1 minute to 100 minutes, 1 minute to 80 minutes, 1 minute to 60 minutes, 1 minute to 40 minutes, or 1 minute to 20 minutes.

Some embodiments relate to a substrate. In some embodiments, the substrate comprises a silicon nitride portion of the substrate. In some embodiments, the substrate comprises a silicon portion of the substrate. In some embodiments, at least 25% of the silicon nitride portion may be removed after contacting a surface of the substrate with the composition. As disclosed herein, the composition comprises a phosphoric acid, a water, and an alkyl silane compound. The alkyl silane compound comprises a compound of the formula:

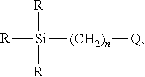

where:
R is independently a hydrogen, a halide, a hydroxide, an alkyl, or an alkoxide;
Q is a cyanide, a carboxylate, an amide, or a quaternary ammonium; and
n is at least 1.

In some embodiments, the substrate may have alternating thin film layers of silicon nitride as structural features of a substrate that includes alternating thin film layers of the silicon nitride layers with silicon oxide. The silicon oxide layers are high aspect ratio structures that contain the silicon nitride layers disposed between the layers of silicon oxide.

In some embodiments, 25% to 99% of the silicon nitride portion, may be removed after contacting the surface with a composition, or any range or subrange between 25% and 99%. The composition may be the composition disclosed herein. For example, in some embodiments, the amount of silicon nitride portion removed after contacting the surface with the composition may range from 30% to 95%, 35% to 90%, 40% to 85%, 45% to 80%, 50% to 75%, 55% to 70%, 60% to 65%. In some embodiments, the amount of silicon nitride portion removed after contacting the surface with the composition may range from 25% to 90%, 25% to 85%, 25% to 80%, 25% to 75%, 25% to 70%, 25% to 65%, 25% to 60%, 25% to 55%, 25% to 50%, 25% to 45%, 25% to 40% 25% to 35%, or 25% to 30%. In some embodiments, the amount of silicon portion removed after contacting the surface with the composition may range from 30% to 99%, 35% to 99%, 40% to 99%, 45% to 99%, 50% to 99%, 55% to 99%, 60% to 99%, 65% to 99%, 70% to 99%, 75% to 99%, 80% to 99%, 85% to 99%, 90% to 99%, or 95% to 99%.

Any one or more of the embodiments disclosed herein shall be understood to be combinable without departing from the scope or spirit of the disclosure.

### Examples

A compound of the formula below was added to an etchant composition:

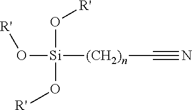

where: R′ is a methyl and n is 2.

The composition exhibited a silicon nitride etch rate of 31.3 Å/min and a silicon oxide etch rate of 0.13 Å/min, with a selectivity of 240 and a silicon loading margin of 500. At room temperature, use of the composition resulted in foaming having a height of less than 11 mm and, at 160° C., the composition resulted in no foaming.

### Aspects

Various Aspects are described below. It is to be understood that any one or more of the features recited in the following Aspect(s) can be combined with any one or more other Aspect(s).

Aspect 1. A composition comprising:
a phosphoric acid;
a water; and
an alkyl silane compound,
   wherein the alkyl silane compound comprises a compound of the formula:

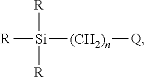

where:
   R is independently a hydrogen, a halide, a hydroxide, an alkyl, or an alkoxide;
   Q is a cyanide, a carboxylate, an amide, or a quaternary ammonium; and
   n is at least 1.
      Aspect 2. The composition according to Aspect 1, wherein each R is a hydroxide.
      Aspect 3. The composition according any one of Aspects 1-2, wherein each R is an alkoxide.
      Aspect 4. The composition according any one of Aspects 1-3, wherein Q is a cyanide and the cyanide comprises:

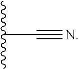 [SMILES: *C#N]

Aspect 5. The composition according any one of Aspects 1-4, wherein Q is an amide and the amide comprises:

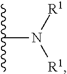

where:
   R¹ is independently an alkyl, an aryl, an isoprene, a silane, a Butyltrimethoxysilane, or a hydrogen.
      Aspect 6. The composition according any one of Aspects 1-5, wherein Q is a carboxylate and the carboxylate comprises:

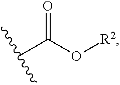

where:
   R² is a hydrogen or an alkyl.
      Aspect 7. The composition according any one of Aspects 1-6, wherein Q is a quaternary ammonium and the quaternary ammonium comprises:

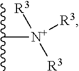

where:
   R³ is independently an alkyl, an aryl, an alkanesulfonic acid, a Butyltrimethoxysilane, a 1-Butanesulfonic acid, or a hydrogen.
      Aspect 8. The composition according any one of Aspects 1-7, wherein the alkyl silane compound comprises a compound of the formula:

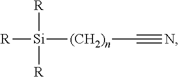

where:
   R is independently a hydrogen, a halide, a hydroxide, an alkyl, or an alkoxide; and
   n is at least 1.
      Aspect 9. The composition according any one of Aspects 1-8, wherein the alkyl silane compound comprises a compound of the formula:

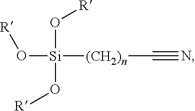

where:
   R′ is independently a hydrogen or an alkyl; and
   n is at least 1.
      Aspect 10. The composition according any one of Aspects 1-9, wherein the alkyl silane compound comprises a compound of the formula:

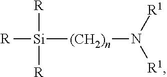

where:
   R is independently a hydrogen, a halide, a hydroxide, an alkyl, or an alkoxide;
   R¹ is independently a hydrogen, an alkyl, a cycloalkyl, an aryl, an alkaryl, an aralkyl, or an alkoxyalkyl; and
   n is at least 1.
      Aspect 11. The composition according any one of Aspects 1-10, wherein the alkyl silane compound comprises a compound of the formula:

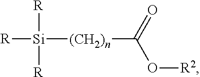

where:
   R is independently a hydrogen, a halide, a hydroxide, an alkyl, or an alkoxide;
   R² is a hydrogen or an alkyl; and
   n is at least 1.
      Aspect 12. The composition according any one of Aspects 1-11, wherein the alkyl silane compound comprises a compound of the formula:

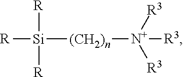

where:
   R is independently a hydrogen, a halide, a hydroxide, an alkyl, or an alkoxide; and
   R³ is independently a hydrogen, an isoprene, or an alkyl.
      Aspect 13. The composition according any one of Aspects 1-13, wherein the composition produces no foam at temperatures ranging from 30° C. to 200° C.
      Aspect 14. A method comprising:
obtaining a structure comprising a silicon nitride and a silicon oxide; and
contacting the structure with a composition to remove at least a portion of the silicon nitride,
   wherein the silicon nitride is selective relative to the silicon oxide; and
   wherein the composition comprises:
      a phosphoric acid;
      a water; and
      an alkyl silane compound,
         wherein the alkyl silane compound comprises a compound of the formula:

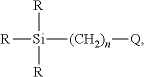

where:
   R is independently a hydrogen, a halide, a hydroxide, an alkyl, or an alkoxide;
   Q is a cyanide, a carboxylate, an amide, or a quaternary ammonium; and
   n is at least 1.
      Aspect 15. The method according to Aspect 14, wherein the alkyl silane compound comprises a compound of the formula:

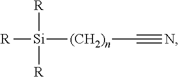

where:
   R is independently a hydrogen, a halide, a hydroxide, an alkyl, or an alkoxide; and
   n is at least 1.
      Aspect 16. The method according any one of Aspects 14-15, wherein the alkyl silane compound comprises a compound of the formula:

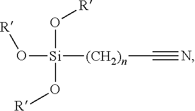

where:
   R′ is independently a hydrogen or an alkyl; and
   n is at least 1.
      Aspect 17. The method according any one of Aspects 14-16, wherein the alkyl silane compound comprises a compound of the formula:

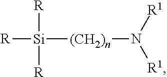

where:
   R is independently a hydrogen, a halide, a hydroxide, an alkyl, an isoprene, or an alkoxide;
   R¹ is independently a hydrogen, an alkyl, a cycloalkyl, an aryl, an alkaryl, an aralkyl, or an alkoxyalkyl; and
   n is at least 1.
      Aspect 18. The method according any one of Aspects 14-17, wherein the alkyl silane compound comprises a compound of the formula:

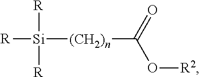

where:
   R is independently a hydrogen, a halide, a hydroxide, an alkyl, or an alkoxide;
   R² is a hydrogen or an alkyl; and
   n is at least 1.
      Aspect 19. The method according any one of Aspects 14-18, wherein the alkyl silane compound comprises a compound of the formula:

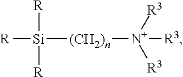

where:
   R is independently a hydrogen, a halide, a hydroxide, an alkyl, or an alkoxide; and
   R³ is a hydrogen, an isoprene, or an alkyl.
      Aspect 20. A device comprising:
a substrate comprising:
   a silicon nitride portion; and
   a silicon oxide portion;
      wherein at least 25% of the silicon nitride portion is removed after contacting a surface of the substrate with a composition comprising:
         a phosphoric acid;
         a water; and
         an alkyl silane compound,
         wherein the alkyl silane compound comprises a compound of the formula:

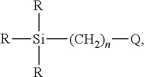

where:
R is independently a hydrogen, a halide, a hydroxide, an alkyl, or an alkoxide;
Q is a cyanide, a carboxylate, an amide, or a quaternary ammonium; and
n is at least 1.

What is claimed is:

1. A composition comprising:
a phosphoric acid;
a water; and
an alkyl silane compound,
wherein the alkyl silane compound comprises a compound of the formula: 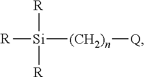
where:
R is independently a hydrogen, a halide, a hydroxide, an alkyl, or an alkoxide;
Q is a cyanide, a carboxylate, an amide, or a quaternary ammonium; and
n is at least 1.

2. The composition of claim 1, wherein each R is a hydroxide.

3. The composition of claim 1, wherein each R is an alkoxide.

4. The composition of claim 1, wherein Q is a cyanide and the cyanide comprises:

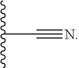 [SMILES: *C#N]

5. The composition of claim 1, wherein Q is an amide and the amide comprises: 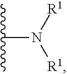
where:
R¹ is independently an alkyl, an aryl, an isoprene, a silane, a Butyltrimethoxysilane, or a hydrogen.

6. The composition of claim 1, wherein Q is a carboxylate and the carboxylate comprises: 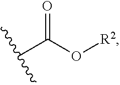
where:
R² is a hydrogen or an alkyl.

7. The composition of claim 1, wherein Q is a quaternary ammonium and the quaternary ammonium comprises: 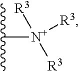
where:
R³ is independently an alkyl, an aryl, an alkanesulfonic acid, a Butyltrimethoxysilane, a 1-Butanesulfonic acid, or a hydrogen.

8. The composition of claim 1, wherein the alkyl silane compound comprises a compound of the formula: 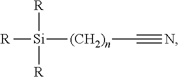
where:
R is independently a hydrogen, a halide, a hydroxide, an alkyl, or an alkoxide; and
n is at least 1.

9. The composition of claim 1, wherein the alkyl silane compound comprises a compound of the formula: 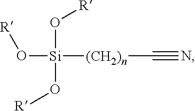
where:
R′ is independently a hydrogen or an alkyl; and
n is at least 1.

10. The composition of claim 1, wherein the alkyl silane compound comprises a compound of the formula: 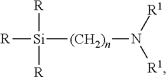
where:
R is independently a hydrogen, a halide, a hydroxide, an alkyl, or an alkoxide;
R¹ is independently a hydrogen, an alkyl, a cycloalkyl, an aryl, an alkaryl, an aralkyl, or an alkoxyalkyl; and
n is at least 1.

11. The composition of claim 1, wherein the alkyl silane compound comprises a compound of the formula: 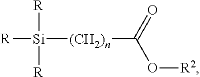
where:
R is independently a hydrogen, a halide, a hydroxide, an alkyl, or an alkoxide;
R² is a hydrogen or an alkyl; and
n is at least 1.

12. The composition of claim 1, wherein the alkyl silane compound comprises a compound of the formula: 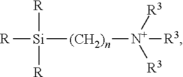
where:
R is independently a hydrogen, a halide, a hydroxide, an alkyl, or an alkoxide; and
R³ is independently a hydrogen, an isoprene, or an alkyl.

13. The composition of claim 1, wherein the composition produces no foam at temperatures ranging from 30° C. to 200° C.

14. A method comprising:
obtaining a structure comprising a silicon nitride and a silicon oxide; and
contacting the structure with a composition to remove at least a portion of the silicon nitride,
wherein the composition comprises:
a phosphoric acid;
a water; and
an alkyl silane compound,
wherein the alkyl silane compound comprises a compound of the formula: 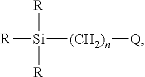
where:
R is independently a hydrogen, a halide, a hydroxide, an alkyl, or an alkoxide;
Q is a cyanide, a carboxylate, an amide, or a quaternary ammonium; and
n is at least 1.

15. The method of claim 14, wherein the alkyl silane compound comprises a compound of the formula: 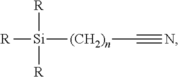
where:
R is independently a hydrogen, a halide, a hydroxide, an alkyl, or an alkoxide; and
n is at least 1.

16. The method of claim 14, wherein the alkyl silane compound comprises a compound of the formula: 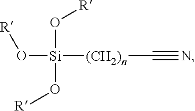
where:
R′ is independently a hydrogen or an alkyl; and
n is at least 1.

17. The method of claim 14, wherein the alkyl silane compound comprises a compound of the formula: 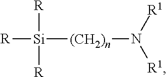
where:
R is independently a hydrogen, a halide, a hydroxide, an alkyl, an isoprene, or an alkoxide;
R¹ is independently a hydrogen, an alkyl, a cycloalkyl, an aryl, an alkaryl, an aralkyl, or an alkoxyalkyl; and
n is at least 1.

18. The method of claim 14, wherein the alkyl silane compound comprises a compound of the formula: 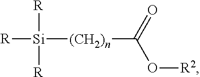
where:
R is independently a hydrogen, a halide, a hydroxide, an alkyl, or an alkoxide;
R² is a hydrogen or an alkyl; and
n is at least 1.

19. The method of claim 14, wherein the alkyl silane compound comprises a compound of the formula: 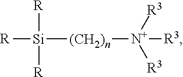
where:
R is independently a hydrogen, a halide, a hydroxide, an alkyl, or an alkoxide; and
R³ is a hydrogen, an isoprene, or an alkyl.

20. A device comprising:
a substrate comprising:
a silicon nitride portion; and
a silicon oxide portion;
wherein at least 25% of the silicon nitride portion is removed after contacting a surface of the substrate with a composition comprising:
a phosphoric acid;
a water; and
an alkyl silane compound,
wherein the alkyl silane compound comprises a compound of the formula: 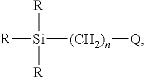
where:
R is independently a hydrogen, a halide, a hydroxide, an alkyl, or an alkoxide;
Q is a cyanide, a carboxylate, an amide, or a quaternary ammonium; and
n is at least 1.
